(19) United States
(12) Patent Application Publication
(10) Pub. No.: US 2016/0231296 A1
(43) Pub. Date: Aug. 11, 2016

(54) BASE STATION FOR LIQUID CHROMATOGRAPHY ANALYSIS UNIT

(71) Applicant: Agilent Technologies, Inc., Santa Clara, CA (US)

(72) Inventors: Thorsten Dressler, Mannheim (DE); Manuela Senf, Karlsruhe (DE); Armin Steinke, Ettlingen (DE); Klaus Witt, Keltern (DE)

(21) Appl. No.: 15/017,053

(22) Filed: Feb. 5, 2016

(30) Foreign Application Priority Data
Feb. 6, 2015 (GB) 1502031.6

(51) Int. Cl. G01N 30/86; B01D 15/10

(52) U.S. Cl. CPC G01N 30/8658; B01D 15/10; G01N 2030/027

(57) ABSTRACT

A base station for separating a fluidic sample by liquid chromatography in cooperation with a liquid chromatography analysis unit configured for executing a predefined liquid chromatography analysis task, wherein the base station comprises an analysis unit coupling section configured for removably coupling the liquid chromatography analysis unit to the base station, and an analysis task identification unit configured for identifying the predefined liquid chromatography analysis task of the liquid chromatography analysis unit coupled to the analysis unit coupling section, so that the fluidic sample is separable by executing the identified predefined liquid chromatography analysis task in cooperation between the base station and the liquid chromatography analysis unit.

### RELATED APPLICATIONS

This application claims priority to UK Patent Application No. GB 1502031.6, filed Feb. 6, 2015, titled “BASE STATION FOR LIQUID CHROMATOGRAPHY ANALYSIS UNIT,” the content of which is incorporated herein by reference in its entirety.

### BACKGROUND ART

The present invention relates to a base station, a liquid chromatography system, and a method of separating a fluidic sample by liquid chromatography by a base station in cooperation with a liquid chromatography analysis unit.

In conventional liquid chromatography, a fluidic sample is injected into a flow path between a high pressure pump and a separation column via a complex injector. The high pressure pump then drives the injected fluidic sample and an eluent (liquid mobile phase) through conduits and the column in which separation of sample components takes place. The column may comprise a material which is capable of separating different components of the fluidic sample. Such a packing material, so-called beads which may comprise silica gel, may be filled into a column tube which may be connected to other elements by conduits. A detector located downstream of the separation column then detects separated fractions of the fluidic sample.

Operation of such a liquid chromatography apparatus supports many different sophisticated and user definable analysis procedures. However, such a liquid chromatography apparatus is technologically complex in construction and requires pronounced operation skills of a user.

### DISCLOSURE

It is an object of the invention to enable liquid chromatography sample separation in a simple way so that it can be executed even by an untrained user.

According to an exemplary embodiment of the present invention, a base station for separating a fluidic sample by liquid chromatography in cooperation with a liquid chromatography analysis unit configured for executing a predefined liquid chromatography analysis task is provided, wherein the base station comprises an analysis unit coupling section configured for removably coupling the liquid chromatography analysis unit to the base station, and an analysis task identification unit configured for identifying the predefined liquid chromatography analysis task of the liquid chromatography analysis unit coupled to the analysis unit coupling section, so that the fluidic sample is separable by executing the identified predefined liquid chromatography analysis task in cooperation between the base station and the liquid chromatography analysis unit.

According to another exemplary embodiment of the present invention, a liquid chromatography system is provided which comprises a base station having the above-mentioned features, and a liquid chromatography analysis unit configured for executing a predefined liquid chromatography analysis task to separate a fluidic sample in cooperation between the base station and the liquid chromatography analysis unit, being removably coupleable to the analysis unit coupling section of the base station, and enabling the analysis task identification unit to identify the predefined liquid chromatography analysis task of the liquid chromatography analysis unit when being coupled to the analysis unit coupling section.

According to yet another exemplary embodiment of the present invention, a method of separating a fluidic sample by liquid chromatography by a base station in cooperation with a liquid chromatography analysis unit being configured for executing a predefined liquid chromatography analysis task is provided, wherein the method comprises removably coupling the liquid chromatography analysis unit to an analysis unit coupling section of the base station, when the liquid chromatography analysis unit is coupled to the analysis unit coupling section, identifying the predefined liquid chromatography analysis task of the liquid chromatography analysis unit by an analysis task identification unit of the base station, and subsequently separating the fluidic sample by executing the identified predefined liquid chromatography analysis task in cooperation between the base station and the liquid chromatography analysis unit.

In the context of the present application, the term “predefined liquid chromatography analysis task” may particularly denote a very specific, not user-adaptable or user-adjustable standardized test of a fluidic sample using liquid chromatography which is defined by the interior constitution of the liquid chromatography analysis unit being prefilled with corresponding consumption materials (such as solvent, separation material, etc.) specifically adapted to a single specified predefined liquid chromatography analysis task. An example for such a predefined liquid chromatography analysis task executable by a certain liquid chromatography analysis unit is a liquid chromatography based test whether or not an orange juice sample contains an amount of fungi above or below a predefined threshold value.

According to an exemplary embodiment of the invention, the analysis unit coupling section precisely defines a position and/or an orientation according to which the liquid chromatography analysis unit is to be coupled to the base station by a user in terms of carrying out the predefined liquid chromatography analysis task. In this coupled state (and in particular only in this coupled state), the analysis task identification unit is enabled to automatically identify which predefined liquid chromatography analysis task a presently inserted liquid chromatography analysis unit is capable to support. This may be achieved by bringing the analysis task identification unit of the base station and an analysis task identifier of the liquid chromatography analysis unit in such a functionally cooperating configuration by the insertion that the information of the supported liquid chromatography analysis task can be made rapidly available for the base station. The base station may then adapt its own configuration or operation in accordance with the identified liquid chromatography analysis task so that no further user action is necessary to configure or calibrate the now combined base station and liquid chromatography analysis unit for subsequent cooperation. Many of the complex components of a conventional liquid chromatography apparatus (such as a high-pressure pump, a robot-operated injector, complex fluidic switch valves, etc.) need not be provided according to an exemplary embodiment of the invention. Hence, the base station (in particular as compact HPLC instrument) may provide an automatic identification of the specific analysis task to be executed, for example so that the instrument will automatically execute a specific separation task when inserting a specific liquid chromatography analysis cartridge (for example containing a respective label or identifier indicating such specific task).

In the following, further exemplary embodiments of the base station, the liquid chromatography system and the method will be explained.

According to an exemplary embodiment of the invention, the analysis unit coupling section comprises an accommodation slot within which at least part of the liquid chromatography analysis unit is removably accommodable. The accommodation slot may receive the liquid chromatography analysis unit, partially or entirely, in an interior thereof so that any exterior distortion of the liquid chromatography analysis task may be safely prevented. For instance, the influence of surrounding daylight on an optical detection can thereby be suppressed.

According to an exemplary embodiment of the invention, the analysis task identification unit is configured as an identifier reader configured for reading data indicative of the predefined liquid chromatography analysis task from an analysis task identifier of the liquid chromatography analysis unit. For example, the identifier reader may be a barcode reader (for instance a one-dimensional barcode reader or a two-dimensional barcode reader), an RFID tag reader, a color code reader and/or an alphanumerical code reader.

According to an exemplary embodiment of the invention, the base station has dimensions of not more than 40 cm, in particular of not more than 30 cm, in each spatial direction (i.e. in x-, y- and z-direction, wherein x, y and z are orthogonal to one another). Hence, the base station may be compact and lightweight and may be carried by a user manually to any desired destination.

According to an exemplary embodiment of the invention, the base station comprises a locking mechanism (for instance a mechanical locking mechanism, a magnetic locking mechanism, etc.) configured for locking or latching the liquid chromatography analysis unit to the analysis unit coupling section. By temporarily locking the liquid chromatography analysis unit upon having coupled it to the analysis unit coupling section until the liquid chromatography analysis task has been completed prevents an undesired disturbance during execution of the liquid chromatography analysis task. This also increases the safety of operation and prevents misuse.

According to an exemplary embodiment of the invention, the base station comprises at least a part of a detector for detecting the separated fluidic sample. For instance, the part of the detector of the base station comprises an electromagnetic radiation source and an electromagnetic radiation detecting unit of an electromagnetic radiation based (for instance fluorescence based) detector, at least part of an impedance based detector and/or a mass spectrometer device. For a resource efficient operation, relatively complex detector components may form part of the base station (which may serve as a detector platform for many different liquid chromatography analysis units), whereas simple detector components (such as a flow cell or a detection window for instance of a fluorescence based detector) may form part of the liquid chromatography analysis unit, which may be configured as a single use or disposable device.

According to an exemplary embodiment of the invention, the base station comprises a detector interface configured for removably or detachably mounting at least a part of a detector for detecting the separated fluidic sample. Via the detector interface, a detector (having a corresponding base station interface) may be reversibly attached to the base station. But taking this measure, a desired or required detector appropriate for a specific liquid chromatography analysis task may be modularly added to the base station. The possibility to exchange the detector mounted to the detector interface increases the flexibility in the range of supported applications.

According to an exemplary embodiment of the invention, the base station comprises an evaluation unit (which may be a processor or form part thereof) configured for evaluating a result of a detection of the separated fluidic sample. Therefore, the evaluation unit may carry out the calculations in accordance with a pre-defined analysis scheme so as to determine a (for instance numerical or logical) result of a liquid chromatography analysis task. For instance, the evaluation unit may access a database storing multiple evaluation algorithms, each of which being assigned to a predefined liquid chromatography analysis task assigned to a set of liquid chromatography analysis units. Thus, depending on the identified analysis task, the appropriate evaluation algorithm may be specifically selected from the database.

According to an exemplary embodiment of the invention, the base station comprises an output unit configured for outputting a human perceivable signal indicative of a result of the separation of the fluidic sample. The human perceivable signal may be an acoustic output (for example an acoustic signal having a frequency, tone and/or duration being indicative of the evaluation result), an optical output (for instance a numerical output on a display, a light signal output having a certain duration and/or color being indicative of the evaluation result) and/or a haptic output (for instance, the base station may vibrate in a way so as to indicate to the user the result of the evaluation).

According to an exemplary embodiment of the invention, the human perceivable signal is only indicative of as to whether the fluidic sample, upon executing the predefined liquid chromatography analysis task on the fluidic sample, has passed or failed a test. For instance, the test may be as to whether a fluidic sample (for instance a food sample) has a contaminant concentration below a (for instance legally defined) threshold value (so that the fluidic sample has passed the test) or above the threshold value (so that the fluidic sample has failed the test). Evaluation and interpretation of complex chromatograms by a user can therefore be dispensable according to an exemplary embodiment.

According to an exemplary embodiment of the invention, the base station comprises a communication unit configured for communicating, in particular wirelessly communicating, data indicative of a result of the predefined liquid chromatography analysis task applied to the fluidic sample to an electronic user device, in particular a portable electronic user device (such as a mobile phone or a tablet PC). Such a communication unit may for instance be configured to communicate via a mobile telephone communication network, the public Internet, wireless LAN, an intranet, Bluetooth or Near Field Communication (NFC). By sending the result of the evaluation to the electronic user device (which may be addressed by a mobile phone number, an email address, an IP address or any other identifier), the measurement result may be directly sent to the device that can be further processed, stored or further communicated. An App or any other kind of software may be installed on the electronic user device so as to provide software for communicating with the base station.

According to an exemplary embodiment of the invention, the base station comprises a fluid container accommodation section configured for accommodating one or more fluid containers accommodating a fluid (such as a liquid, for instance a buffer and/or a solvent) to be used when executing the predefined liquid chromatography analysis task. For example, a container containing a buffer solution of relatively high volume may be mounted at the base station to make the disposable single-use liquid chromatography analysis unit more resource efficient by reducing the amount of waste. In an embodiment, it is also possible that one or more solvents used for the liquid chromatography analysis task to be executed in cooperation between the liquid chromatography analysis unit and the base station are accommodated on an/or in the base station, additionally or alternatively to one or more solvents accommodated within the liquid chromatography analysis unit.

According to an exemplary embodiment of the invention, the base station comprises a solvent and sample drive force unit (such as a pump) configured for applying a solvent and sample drive force for driving at least one solvent and fluidic sample in the liquid chromatography analysis unit towards the sample separation unit when coupled to the analysis unit coupling section. For instance, the solvent and sample drive force unit comprises a mechanically actuable drive unit (for instance an electric engine powering a piston), a chemically actuable drive unit (for instance generating energy by an exothermic chemical reaction), a gas pressure generator (such as a pressurized gas bottle capable of generating an overpressure for driving a piston) or a pneumatically and/or hydraulically actuable drive unit (using a gas and/or a liquid for generating the solvent and sample drive force).

According to an exemplary embodiment of the invention, the base station comprises a user authorization section configured for carrying out a user authorization test (before approving execution of a liquid chromatography analysis task) and for rejecting execution of the liquid chromatography analysis task when the user authorization test fails. For example, the user authorization section comprises a fingerprint sensor or an authorization card detector (wherein a card used for authorization may be chip card, a transponder, an identity card, etc.). By requiring a user to identify and authorize himself before execution of the liquid chromatography analysis task in cooperation between the base station and the liquid chromatography analysis unit, unauthorized use of the device may be avoided and the safety of operation may be increased.

According to an exemplary embodiment of the invention, the analysis unit coupling section is configured for coupling the liquid chromatography analysis unit to the base station by a mechanical coupling, a data communication coupling, an electric coupling, and/or a fluidic coupling. Advantageously, mechanically coupling the liquid chromatography analysis unit to the analysis unit coupling section of the base station may automatically establish fluidic connection between liquid chromatography analysis unit and base station. Then, a fluid may flow between the liquid chromatography analysis unit and the base station during executing the liquid chromatography analysis task. Even electric energy and/or electric (or optical) signals may be supplied from the base station to the liquid chromatography analysis unit, or in an opposite direction, wherein the electric connection can be established upon mechanically coupling the electric mobility analysis unit to the analysis unit coupling section. This simplifies use of the liquid chromatography system by the user.

According to an exemplary embodiment of the invention, the liquid chromatography analysis unit (in particular when being embodied as a cartridge) is configured for being coupled to, in particular for being at least partially insertable in, a base station cooperating with the liquid chromatography analysis unit for executing the predefined liquid chromatography analysis task. Both cartridge and base station may be configured as portable devices. In the context of the present application, the term “portable devices” shall in particular denote devices which can be easily carried manually by an average size adult user.

According to an exemplary embodiment of the invention, the method further comprises selecting one of a plurality of different liquid chromatography analysis units, each of which being configured for executing a different predefined liquid chromatography analysis task. By making the selection, the user may define one user-selected liquid chromatography analysis task from a set of available tasks which fits best for a user-defined purpose. Any of the corresponding liquid chromatography analysis units may then be used with one and the same base station, depending on which liquid chromatography analysis a user presently wishes to carry out. Hence, a single multi-purpose base station may be combined by a user flexibly for a certain liquid chromatography analysis task. This keeps operation simple, but nevertheless expands the functionality of the system to many different liquid chromatography analysis tasks. Via different analysis path identifiers of the different liquid chromatography analysis units, the base station may self-sufficiently detect which liquid chromatography analysis task it has to support at present. The base station may have stored in a storage device thereof operation parameters being required for executing the respective liquid chromatography analysis task. After identifying a certain liquid chromatography analysis task, the base station may access the required operation data from the storage device.

According to an exemplary embodiment of the invention, the method further comprises, after executing the predefined liquid chromatography analysis task, decoupling the liquid chromatography analysis unit from the base station, subsequently coupling another liquid chromatography analysis unit to the base station, and executing another liquid chromatography analysis task in cooperation between the other liquid chromatography analysis unit and the base station. Thus, a modular construction set of one single base station and multiple different liquid chromatography analysis units serving different liquid chromatography analysis tasks is provided which allows even an untrained user to flexibly adapt the system to his or her preferences.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography system according to an exemplary embodiment of the invention comprising a liquid chromatography analysis unit and a base station.

FIG. 2 illustrates a liquid chromatography system according to another exemplary embodiment of the invention.

FIG. 3 illustrates a liquid chromatography analysis unit according to an exemplary embodiment of the invention.

FIG. 4 illustrates a set of liquid chromatography analysis units according to an exemplary embodiment of the invention.

The illustrations in the drawings are schematic.

Before, referring to the drawings, exemplary embodiments will be described in further detail, some basic considerations will be summarized based on which exemplary embodiments of the invention have been developed.

According to an exemplary embodiment, an HPLC (high performance liquid chromatography) cartridge analyzer is provided.

The schematic of a conventional HPLC instrument typically includes a sampler, pumps, and a detector. The sampler brings a sample mixture into a mobile phase stream which carries it into a separation column. The pumps deliver the desired flow and composition of the mobile phase through the column. The detector generates a signal proportional to the amount of sample component emerging from the column, hence allowing for quantitative analysis of the sample components. Typically all the described components are arranged in modules with individual housings stacked above each other or built all in one enclosure.

However, users of conventional HPLC instruments need to know the special requirements and needed configuration for their purpose to set up and maintain the liquid chromatography stack correctly. The needed detailed knowledge limits significantly the user group. Users without HPLC expertise are excluded.

A cartridge analyzer according to an exemplary embodiment of the invention offers a solution for dedicated applications, which can be used without any HPLC background expertise or knowledge.

Mixture of solvents, type of capillaries, type of column materials and appropriate HPLC modules like pumps, samplers and column compartments are conventionally depending on the components which are interesting. A cartridge analyzer according to an exemplary embodiment may reduce these complex configurations to one instrument. Open handling of solvents is not needed anymore. Solvents and buffers may be provided by the cartridge and automatically mixed. Exemplary embodiments also include the possibility for the user to add sample preparation to the workflow in a simple way. A detector module may be added as needed.

A workflow of a liquid chromatography system according to an exemplary embodiment of the invention is:

1. Switch on the base station and check a pressure supply.

2. Insert a liquid chromatography analysis unit which may be embodied as HPLC cartridge, and close a latch.

3. Press start (or start the execution of the liquid chromatography analysis task according to which the liquid chromatography analysis unit is equipped in another way) and wait for the result.

Before the user can start the next analysis, the used cartridge is removed, and another liquid chromatography analysis unit is inserted into the base station.

According to an exemplary embodiment, sample preparation can be done in a similar way in a HPLC sample preparation module for the dedicated sample:

1. Switch on the base station.

2. Insert an original sample in an appropriate container and check the level of needed supplies.

3. Insert the needed liquid chromatography analysis unit, such as a HPLC cartridge, into a recess of the base station.

4. Press start (or start the execution of the sample separation task according to which the liquid chromatography analysis unit is equipped in another way) and the sample will be prepared as needed (for instance crush, grind, extraction, centrifugation, and filtration) and automatically filled into the cartridge.

5. Remove the prepared cartridge and insert it into the HPLC cartridge analyzer.

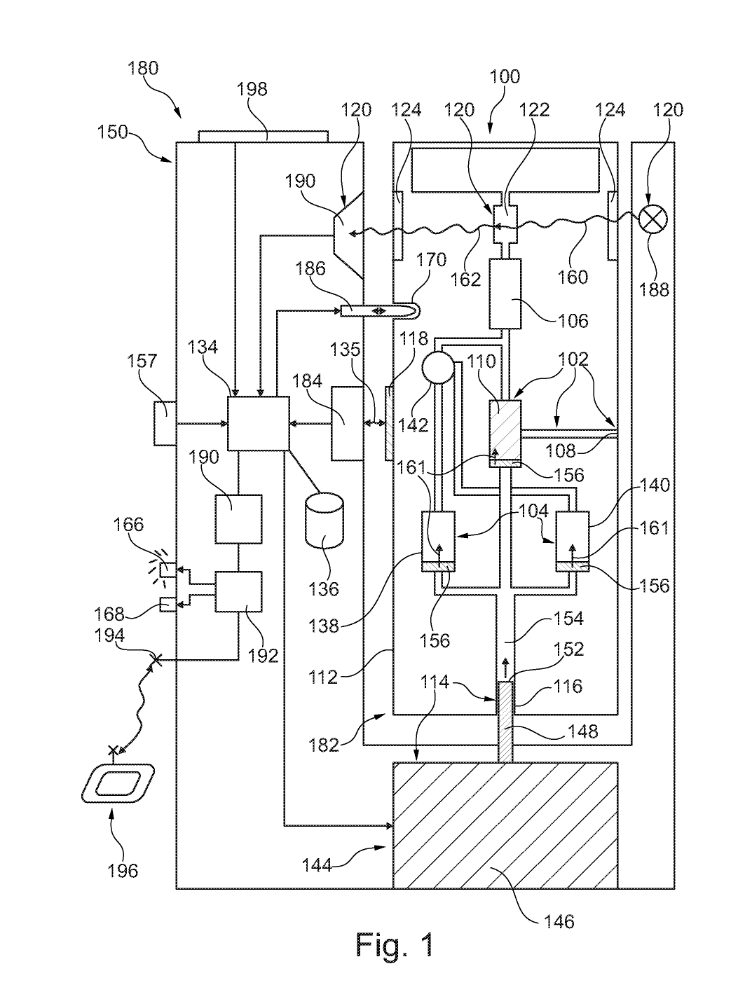

FIG. 1 illustrates a liquid chromatography system 180 according to an exemplary embodiment of the invention constituted by two selectively connectable and disconnectable components, i.e. a portable application-specific single-use cartridge-type liquid chromatography analysis unit 100 which is only capable of executing a specific predefined liquid chromatography analysis task, and a portable multiple use and multiple purpose base station 150.

The base station 150 is configured for being removably or detachably coupled to the liquid chromatography analysis unit 100 for executing the predefined liquid chromatography analysis task. For coupling the base station 150 and the liquid chromatography analysis unit 100 to one another, the cartridge-type liquid chromatography analysis unit 100 is inserted by a user into an accommodation recess or accommodation slot as an analysis unit coupling section 182 of the base station 150. A mutually corresponding shaping of the accommodation recess and the liquid chromatography analysis unit 100 ensures that a user can only correctly insert the liquid chromatography analysis unit 100 into the base station 150. Incorrect insertion of the liquid chromatography analysis unit 100 into the base station 150 may be mechanically prevented or disabled.

The liquid chromatography analysis unit 100 is configured for only executing the predefined liquid chromatography analysis task to separate a fluidic sample by executing the predefined liquid chromatography analysis task in cooperation between the base station 150 and the liquid chromatography analysis unit 100. This means that the entire configuration for the liquid chromatography analysis unit 100 in terms of solvents, separation medium, chromatographic method and output analysis result is limited to only one single liquid chromatography analysis task (for instance determination of a specific contaminant load of certain food under test). Other liquid chromatography analysis tasks are not supported by the liquid chromatography analysis unit 100. In the described embodiment, adaptation or modification of the liquid chromatography analysis task by a user is neither possible nor allowed.

The base station 150 is configured for separating a fluidic sample to be inserted into the liquid chromatography analysis unit 100 by liquid chromatography in cooperation with the presently connected liquid chromatography analysis unit 100. An analysis task identification unit 184 (here configured as RFID reader) of the base station 150 is configured for identifying the predefined liquid chromatography analysis task (i.e. the only LC based test which can be carried out using the correspondingly configured liquid chromatography analysis unit 100) supported by the liquid chromatography analysis unit 100. In view of the limited spatial detection range (compare reference numeral 135) of the analysis task identification unit 184, the task identification can only be successfully carried out when the liquid chromatography analysis unit 100 is coupled to the analysis unit coupling section 182, i.e. is properly located within the accommodation slot. In other words, in view of the limited spatial detection range of the analysis task identification unit 184, it is advantageously only capable of reading out the analysis task identifier 118 of the liquid chromatography analysis unit 100 when the latter is received within the analysis unit coupling section 182. By taking this measure, incorrect identification events of identifying unrelated liquid chromatography analysis units 100 located in the environment of the base station 150 may be prevented. The analysis task identification unit 184 determines this information by reading out an RFID tag as the analysis task identifier 118 attached to or forming part of an exterior surface of a plastic casing 112 of the liquid chromatography analysis unit 100. The RFID tag carries the information which liquid chromatography analysis task the assigned liquid chromatography analysis unit 100 is configured to carry out. When the base station 150 has derived this information by a reading operation symbolized with reference numeral 135 in FIG. 1, a control unit 134 (such as a processor) may access a database 136 (such as a data storage device) of the base station 150 to obtain control data for controlling the liquid chromatography system 180 to execute the identified liquid chromatography analysis task. Hence, in the shown embodiment, the consumables used for executing the liquid chromatography analysis task are contributed by the liquid chromatography analysis unit 100, whereas the software for controlling the liquid chromatography analysis task is contributed by the base station 150. While executing the liquid chromatography analysis task, the fluidic sample is separated under control of the control unit 134 in cooperation between the base station 150 and the liquid chromatography analysis unit 100.

The base station 150 furthermore comprises a latch or locking mechanism 186 cooperating with a correspondingly shaped locking recess 170 of the liquid chromatography analysis unit 100 and being configured for locking the liquid chromatography analysis unit 100 to the analysis unit coupling section 182 when the coupling procedure is completed. The locking mechanism 186 can be actuated (i.e. transferred between a locked state and an unlocked state) by the control unit 134. This allows to selectively lock (during the liquid chromatography analysis) or release (during attaching or detaching the liquid chromatography analysis unit 100 with regard to the base station 150) the liquid chromatography analysis unit 100 with regard to the base station 150.

In order to enable the liquid chromatography analysis unit 100 for executing the predefined liquid chromatography analysis task, the liquid chromatography analysis unit 100 is, in the shown embodiment, equipped with all required consumables for one analysis run. The liquid chromatography analysis unit 100 comprises a sample insertion compartment 102 configured for inserting a fluidic sample to be separated. Moreover, the liquid chromatography analysis unit 100 comprises a solvent accommodation section 104 accommodating a predefined volume of different solvents required for executing the specified liquid chromatography analysis task. A sample separation unit 106 of the liquid chromatography analysis unit 100 is configured for separating the fluidic sample inserted into the sample insertion compartment 102. To start the separation procedure, it is sufficient to apply a solvent and sample drive force to the sample and the solvents within the liquid chromatography analysis unit 100 for driving the solvent and the fluidic sample through the sample separation unit 106. The sample separation unit 106 is configured as a liquid chromatography sample separation column filled with separation medium in accordance with the predefined liquid chromatography analysis task. The mentioned procedure will be explained in the following in further detail:

The sample insertion compartment 102 comprises a sample accommodation volume 110 in fluid communication with a sample insertion interface 108. The sample insertion interface 108 allows to insert the liquid sample from an exterior of the liquid chromatography analysis unit 100 via a connection channel into the sample accommodation volume 110 of the sample insertion compartment 102. Sample insertion may be accomplished by a user who may insert the fluidic sample into the sample separation volume 110 by a manually operable insertion tool such as a syringe (not shown). The amount of sample to be filled in is defined by the value of the interior volume of the sample accommodation volume 110.

The solvent accommodation section 104 comprises two containers 138, 140 each of which being filled with a respectively predefined volume of a certain solvent. In the shown embodiment, container 138 is filled with water, whereas container 140 is filled with an organic solvent such as acetonitrile (ACN). Merely by applying pressure as described below, a solvent and sample drive force is exerted so that the solvents in the containers 138, 140 are forced to flow into a mixer 142. In the mixer 142, the solvents are mixed in accordance with a predefined mixing ratio so that a defined solvent composition is generated in accordance with the liquid chromatography analysis task to be carried out. A time-dependent functionality of the mixer 142 may be predefined in such a way that a gradient profile of time-varying solvent composition is guided towards the sample separation unit 106 merely by applying constant pressure to the containers 138, 140.

The liquid chromatography analysis unit 100 furthermore comprises a plastic casing 112 circumferentially enclosing the sample insertion compartment 102, the solvent accommodation section 104 and the sample separation unit 106 while allowing fluid communication with an exterior of the liquid chromatography analysis unit 100 via the sample insertion interface 108.

The liquid chromatography analysis unit 100 comprises a drive unit interface 116 configured for being coupled with an exterior solvent and sample drive unit 114. The latter is, in turn, configured for generating a driving force for driving the fluidic sample in the sample insertion compartment 102 to flow along a predefined fluidic path within the liquid chromatography analysis unit 100 and the solvents in the solvent accommodation section 104 when the solvent and sample drive unit 114 is coupled to the drive unit interface 116. More specifically, a bottom of the base station 150 has a recess 144 in which the solvent and sample drive unit 114 is presently inserted, and from which the solvent and sample drive unit 114 may be removed. In the shown embodiment, the solvent and sample drive unit 114 comprises a gas generation cartridge 146 capable of generating gas pressure, for instance upon receipt of a trigger signal from the control unit 134. When the solvent and sample drive unit 114 is inserted into the recess 144, a gas tube 148 of the solvent and sample drive unit 114 extends into a gas supply channel 154 of the drive unit interface 116 so that generated gas with overpressure enters via a gas supply opening 152 of the gas tube 148 into gas supply channel 154 within the liquid chromatography analysis unit 100. When an overpressure is present in the gas supply channel 154, displaceable pistons 156 in the containers 138, 140 and in the sample separation volume 110 move forwardly (i.e. upwardly according to FIG. 1, see arrows 161) and thereby press the solvent and the fluidic sample through the shown fluidic conduits and subsequently into the sample separation unit 106. Fractions of the fluidic sample will be adsorbed at the sample separation unit 106, in accordance with the principle of liquid chromatography. When the solvent composition with gradient profile subsequently flows through the sample separation unit 106, the fractions will be desorbed one after the other and will flow, as separated fractions of the fluidic sample, from the sample separation unit 106 towards a flow cell 122 of a detector 120.

The detector 120, which is embodied as electromagnetic radiation based fluorescence detector, partially forms part of the liquid chromatography analysis unit 100 and partially forms part of the base station 150.

The part of the detector 120 belonging to the liquid chromatography analysis unit 100 comprises the above-mentioned flow cell 122, and comprises detection windows 124 for externally exposing the separated fluidic sample and being transparent for electromagnetic radiation used for detecting the separated fluidic sample from an exterior of the liquid chromatography analysis unit 100. The other part of the detector 120 belonging to the base station 150 comprises an electromagnetic radiation source 188 and an electromagnetic radiation detector 190 such as a fluorescence detector. The electromagnetic radiation source 188 generates a primary electromagnetic radiation beam 160 which propagates through one of the detection windows 124 and through the flow cell 122 and thereby comes in interaction with the separated fractions of the fluidic sample flowing therethrough. By the interaction with the separated fractions of the fluidic sample, a secondary electromagnetic radiation beam 162 is generated which propagates through the other detection window 124 towards the electromagnetic radiation detector 190. The electromagnetic radiation detector 190 generates a detection signal as a raw analysis result which is forwarded to the control unit 134.

The only actions a user has to take for executing the liquid chromatography analysis task are to select an appropriate liquid chromatography analysis unit 100 fulfilling this liquid chromatography analysis task, inserting the fluidic sample into the sample insertion compartment 102, inserting the cartridge type liquid chromatography analysis unit 100 in the analysis unit coupling section 182 of the base station 150, inserting the solvent and sample drive unit 114 into the recess 144 of the base station 150 and pressing a start button 157 (or actuating any other analysis start actuator) for triggering the control unit 134 for starting the separation.

The base station 150 furthermore comprises an evaluation unit 190 configured for evaluating a result of a detection of the separated fluidic sample. For instance, the evaluation unit 190 uses the raw analysis results as received from the detector 120 and calculates or estimates an analysis result, for instance being merely indicative of whether or not a fluidic sample has passed or failed a certain test in accordance with the liquid chromatography analysis task (for instance, a food sample has passed the test when a determined contaminants load is below a predefined threshold level, and has failed the test when the determined contaminants load is above the predefined threshold level).

The base station 150 moreover comprises an output unit 192 configured for outputting a human perceivable signal indicative of a result of the separation of the fluidic sample, in the present example an optical output. The optical output is made by controlling either a green LED 166 or a red LED 168 to emit light. For instance, when the food sample has passed the test, only the green LED 166 is illuminated. When the sample has failed the test, only the red LED 168 is illuminated.

The base station 150 also comprises a communication unit 194 configured for wirelessly communicating data indicative of a result of the predefined liquid chromatography analysis task applied to the fluidic sample to a portable electronic user device 196 such as a mobile phone on which a corresponding App may be installed. The result of the test can then be displayed to the user via the electronic user device 196.

Furthermore, the base station 150 comprises a user authorization section 198 configured for carrying out a user authorization test and for rejecting execution of the liquid chromatography analysis task when the user authorization test fails. The user authorization section 198 can be embodied as a fingerprint sensor.

FIG. 2 illustrates a liquid chromatography system 180 according to an exemplary embodiment of the invention. In the embodiment of FIG. 2, the base station 150 comprises a detector interface 200 configured for removably mounting a detector 120 for detecting the separated fluidic sample. In the shown embodiment, the detector 120 is completely attached to the detector interface 200 of the base station 150 so that no detector components need to implemented in the cartridge type liquid chromatography analysis unit 100. Furthermore, the base station 150 according to FIG. 2 comprises a fluid container accommodation section 202 which is configured for accommodating a buffer container 204 accommodating a buffer which can be used when executing the predefined liquid chromatography analysis task. All components of the base station 150 are mounted on or in an exterior casing 206.

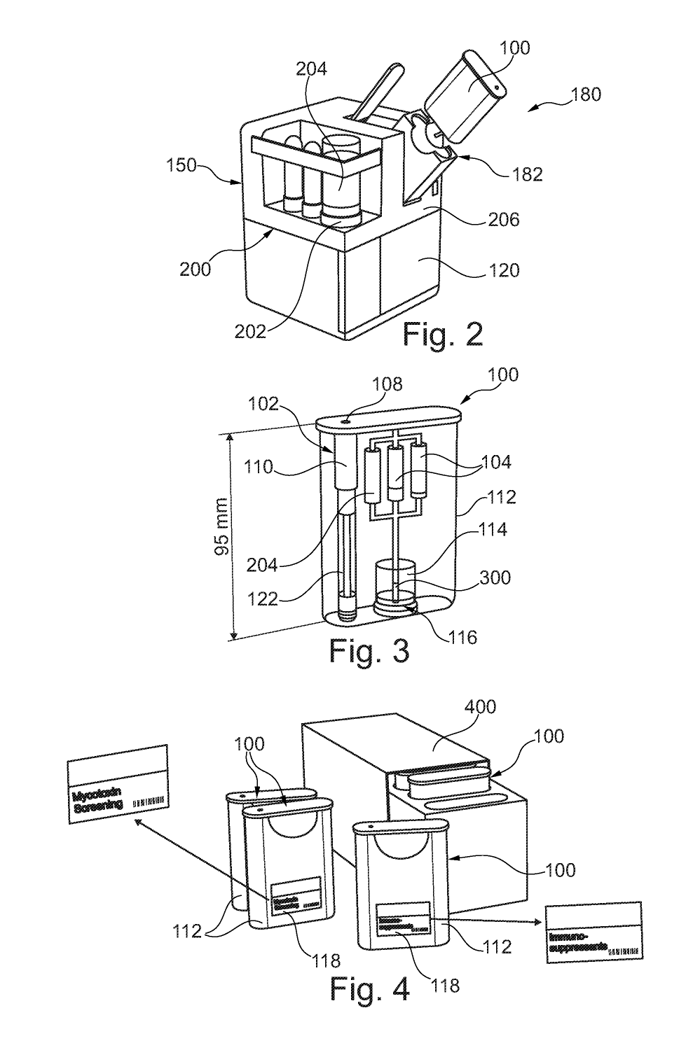

FIG. 3 illustrates a liquid chromatography analysis unit 100 according to an exemplary embodiment of the invention.

According to FIG. 3, also buffer container 204 is integrated in the liquid chromatography analysis unit 100 rather than forming part of the base station 150. A height of the liquid chromatography analysis unit 100 according to FIG. 3 is 95 mm. The height constitutes the largest dimension of the compact liquid chromatography analysis unit 100.

The fluidic sample is inserted by a user via the sample insertion interface 108 configured as manual injector. The solvent and sample drive unit 114 is partially integrated in the liquid chromatography analysis unit 100 according to FIG. 3. A gas inlet constitutes the drive unit interface 116, and a step piston 300 forms part of the solvent and sample drive unit 114.

FIG. 4 illustrates a set of liquid chromatography analysis units 100 according to an exemplary embodiment of the invention.

The various liquid chromatography analysis units 100 are stored in a storage box 400. Analysis task identifiers 118 of the individual liquid chromatography analysis units 100 indicate to a user (in alphanumerical form) and a barcode reader (in form of a machine-readable barcode) which specific liquid chromatography analysis task can be executed by the respective liquid chromatography analysis unit 100.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A base station for separating a fluidic sample by liquid chromatography in cooperation with a liquid chromatography analysis unit configured for executing a predefined liquid chromatography analysis task, wherein the base station comprises:
an analysis unit coupling section configured for removably coupling the liquid chromatography analysis unit to the base station;
an analysis task identification unit configured for identifying the predefined liquid chromatography analysis task of the liquid chromatography analysis unit coupled to the analysis unit coupling section, so that the fluidic sample is separable by executing the identified predefined liquid chromatography analysis task in cooperation between the base station and the liquid chromatography analysis unit.

2. The base station according to claim 1, wherein the analysis unit coupling section comprises an accommodation slot within which at least part of the liquid chromatography analysis unit is removably accommodable.

3. The base station according to claim 1, wherein the analysis task identification unit is configured as an identifier reader configured for reading data indicative of the predefined liquid chromatography analysis task from an analysis task identifier of the liquid chromatography analysis unit, in particular is configured as one of the group consisting of a barcode reader, more particularly a one-dimensional barcode reader or a two-dimensional barcode reader, an RFID tag reader, a color code reader, and an alphanumerical code reader.

4. The base station according to claim 1, comprising at least a part of a detector for detecting the separated fluidic sample.

5. The base station according to claim 4, wherein the part of the detector of the base station comprises at least one of the group consisting of an electromagnetic radiation source and an electromagnetic radiation detecting unit of an electromagnetic radiation based detector, at least part of an impedance based detector, and a mass spectrometer device.

6. The base station according to claim 1, comprising a detector interface configured for removably mounting at least a part of a detector for detecting the separated fluidic sample.

7. The base station according to claim 1, comprising an output unit configured for outputting a human perceivable signal indicative of a result of the separation of the fluidic sample, in particular at least one human perceivable signal of the group consisting of an acoustic output, an optical output, and a haptic output.

8. The base station according to claim 7, wherein the human perceivable signal is only indicative of as to whether the fluidic sample, upon executing the predefined liquid chromatography analysis task on the fluidic sample, has passed or failed a test.

9. The base station according to claim 1, further comprising a solvent and sample drive force unit configured for applying a solvent and sample drive force for driving at least one solvent and fluidic sample in the liquid chromatography analysis unit when coupled to the analysis unit coupling section.

10. The base station according to claim 9, wherein the solvent and sample drive force unit comprises at least one of the group consisting of a mechanically actuable drive unit, a chemically actuable drive unit, a gas pressure generator, and a pneumatically actuable drive unit.

11. The base station according to claim 1, comprising a user authorization section configured for carrying out a user authorization test and for rejecting execution of the liquid chromatography analysis task when the user authorization test fails.

12. The base station according to claim 11, wherein the user authorization section comprises at least one of the group consisting of a fingerprint sensor and an authorization card detector.

13. The base station according to claim 1, comprising at least one of the following features:
the analysis unit coupling section is configured for coupling the liquid chromatography analysis unit to the base station by at least one of the group consisting of a mechanical coupling, a data communication coupling, an electric coupling, and a fluidic coupling;
the base station comprises a communication unit configured for communicating, in particular wirelessly communicating, data indicative of a result of the predefined liquid chromatography analysis task applied to the fluidic sample to an electronic user device, in particular a portable electronic user device, more particularly one of the group consisting of a mobile phone and a tablet PC;
the base station further comprises a fluid container accommodation section configured for accommodating a fluid container accommodating a fluid to be used when executing the predefined liquid chromatography analysis task;
the base station comprises an evaluation unit configured for evaluating a result of a detection of the separated fluidic sample;
the base station has dimensions of not more than 40 cm, in particular of not more than 30 cm, in each spatial direction;
the base station comprises a locking mechanism configured for locking the liquid chromatography analysis unit to the analysis unit coupling section.

14. A liquid chromatography system, wherein the liquid chromatography system comprises:
a base station according to claim 1;
a liquid chromatography analysis unit configured for:
executing a predefined liquid chromatography analysis task to separate a fluidic sample in cooperation between the base station and the liquid chromatography analysis unit;
being removably coupleable to the analysis unit coupling section of the base station;
enabling the analysis task identification unit to identify the predefined liquid chromatography analysis task of the liquid chromatography analysis unit when being coupled to the analysis unit coupling section.

15. The liquid chromatography system according claim 14, further comprising at least one of the following features:
the liquid chromatography system further comprises a detector for detecting the separated fluidic sample and being at least partially mountable to a detector interface of the base station;
the liquid chromatography analysis unit comprises at least a part of a detector configured for detecting the separated fluidic sample;
the liquid chromatography analysis unit is configured as a cartridge, in particular as a disposable cartridge for single-use or for use for only for a limited number of times;
the liquid chromatography analysis unit has dimensions of not more than 15 cm, in particular of not more than 10 cm, in each spatial direction;
the liquid chromatography analysis unit comprises an analysis task identifier, in particular a machine-readable analysis task identifier, configured for identifying the predefined liquid chromatography analysis task to be executed by the liquid chromatography analysis unit;
the liquid chromatography analysis unit is configured for being at least partially insertable in the base station cooperating with the liquid chromatography analysis unit for executing the predefined liquid chromatography analysis task.

16. The liquid chromatography system according claim 14, wherein the liquid chromatography analysis unit comprises:
a sample insertion compartment configured for inserting a fluidic sample to be separated when executing the liquid chromatography analysis task;
a solvent accommodation section accommodating a predefined volume of at least one predefined solvent required for executing the liquid chromatography analysis task;
a sample separation unit configured for separating the fluidic sample inserted into the sample insertion compartment upon applying a solvent and sample drive force for driving the solvent and the fluidic sample through the sample separation unit.

17. The liquid chromatography system according claim 16, further comprising at least one of the following features:
the sample insertion compartment comprises a sample insertion interface configured for inserting the fluidic sample from an exterior of the liquid chromatography analysis unit into a sample accommodation volume of the sample insertion compartment;
the solvent accommodation section comprises at least two predefined volumes of at least two predefined solvents and is configured so that a solvent composition in form of a mixture of the at least two predefined solvents in accordance with a predefined temporally varying solvent gradient profile is supplied to the sample separation unit upon applying the solvent and sample drive force;
the sample separation unit is configured as sample separation column;
the liquid chromatography analysis unit comprises a casing enclosing at least part of the sample insertion compartment, the solvent accommodation section and the sample separation unit;
the liquid chromatography analysis unit has, integrated therein and/or removably coupleable thereto, at least part of a solvent and sample drive unit configured for generating a driving force for driving the fluidic sample in the sample insertion compartment and the at least one solvent in the solvent accommodation section to the sample separation unit;
the liquid chromatography analysis unit comprises a drive unit interface configured for being coupled with an at least partially exterior solvent and sample drive unit configured for generating a driving force for driving the fluidic sample in the sample insertion compartment and the at least one solvent in the solvent accommodation section to the sample separation unit when the solvent and sample drive unit is coupled to the drive unit interface.

18. A method of separating a fluidic sample by liquid chromatography by a base station in cooperation with a liquid chromatography analysis unit being configured for executing a predefined liquid chromatography analysis task, wherein the method comprises:
removably coupling the liquid chromatography analysis unit to an analysis unit coupling section of the base station;
when the liquid chromatography analysis unit is coupled to the analysis unit coupling section, identifying the predefined liquid chromatography analysis task of the liquid chromatography analysis unit by an analysis task identification unit of the base station;
subsequently separating the fluidic sample by executing the identified predefined liquid chromatography analysis task in cooperation between the base station and the liquid chromatography analysis unit.

19. The method according to claim 18, wherein the method further comprises selecting one of a plurality of different liquid chromatography analysis units, each of which being configured for executing a different predefined liquid chromatography analysis task, for executing a user-selected liquid chromatography analysis task for a user-defined purpose.

20. The method according to claim 18, wherein the method further comprises:
after executing the predefined liquid chromatography analysis task, decoupling the liquid chromatography analysis unit from the base station;
subsequently coupling another liquid chromatography analysis unit to the base station;
executing another liquid chromatography analysis task in cooperation between the other liquid chromatography analysis unit and the base station.
